(19) United States
(12) Patent Application Publication
(10) Pub. No.: US 2014/0255736 A1
(43) Pub. Date: Sep. 11, 2014

(54) NON-AQUEOUS ELECTROLYTE SECONDARY BATTERY

(71) Applicant: TOYOTA JIDOSHA KABUSHIKI KAISHA, Toyota-shi, Aichi (JP)

(72) Inventor: Masaru Takagi, Aichi (JP)

(21) Appl. No.: 14/351,193

(22) PCT Filed: Oct. 12, 2011
(86) PCT No.: PCT/JP2011/005720

§ 371 Date: Apr. 11, 2014

(51) Int. Cl. H01M 2/34

(52) U.S. Cl. CPC H01M 2/345
USPC 429/61

(57) ABSTRACT

Provided is a non-aqueous electrolyte secondary battery excellent in resistance to an external stress and capable of increasing the sensitivity for detecting a rise in internal pressure during an overcharge state, without deteriorating battery performances such as a battery capacity. The non-aqueous electrolyte secondary battery includes a positive electrode (21); a negative electrode (22); a porous heat resistance layer (24) disposed between the positive electrode (21) and the negative electrode (22) and including an insulating inorganic filler and a binder; a non-aqueous electrolyte including an overcharge inhibitor that is dissolved and generates protons during an overcharge state; and a current interruption mechanism that interrupts charging when a battery internal pressure becomes equal to or more than a predetermined value during charging. At least a part of the insulating inorganic filler of the porous heat resistance layer (24) is foamed of proton conductive ceramic.

### TECHNICAL FIELD

The present invention relates to a non-aqueous electrolyte secondary battery.

### BACKGROUND ART

Conventional non-aqueous electrolyte secondary batteries, such as lithium ion secondary batteries, are roughly composed of a positive electrode, a negative electrode, a separator that isolates the positive electrode and the negative electrode, and a non-aqueous electrolyte. A polyolefin porous resin film, for example, is widely used as the separator.

In some cases, the non-aqueous electrolyte secondary batteries, such as lithium ion secondary batteries, are mounted with a current interruption mechanism, which interrupts charging when a battery internal pressure becomes equal to or more than a predetermined value during charging, as a safety measure during an overcharge state (for example, see paragraph 0094 of Patent Literature 1).

In Patent Literature 1, an overcharge inhibitor, which is dissolved during an overcharge state and generates protons, is added to the non-aqueous electrolyte so as to increase the sensitivity for detecting a rise in internal pressure. In this configuration, the overcharge inhibitor is dissolved and generates protons during the overcharge state. The protons are reduced at the negative electrode, so that hydrogen gas is generated.

The “Description of the Prior Art” section of Patent Literature 1 discloses, as examples of the overcharge inhibitor, biphenyls, alkylbenzenes, an alkyl compound substituted with two aromatic groups, fluorine atom substituted aromatic compounds, and chlorine atom substituted biphenyl (paragraphs 0009, 0011, and 0014).

Claim 1 of Patent Literature 1 discloses, as the overcharge inhibitor, at least one type of chlorine atom substituted aromatic compound selected from the group consisting of chlorine atom substituted biphenyl, chlorine atom substituted naphthalene, chlorine atom substituted fluorene, and chlorine atom substituted diphenylmethane.

Incidentally, when an external stress is applied to the non-aqueous electrolyte secondary battery that incorporates a porous resin film made of polyolefin or the like as a separator, the non-aqueous electrolyte is pushed out of the separator, which may result in reducing the ion conductivity of the separator and deteriorating battery performances (paragraph 0004 of Patent Literature 2).

Patent Literature 2 discloses a non-aqueous electrolyte secondary battery in which a porous heat resistance layer (HRL layer) that has high rigidity and includes an insulating inorganic filler and a binder is incorporated in place of a conventional resin separator, or in combination with the conventional resin separator (Claim 5, FIGS. 1 and 3).

As the insulating inorganic filler of the porous heat resistance layer GIRL layer), at least one type selected from the group consisting of Al₂O₃, SiO₂, MgO, TiO₂, and ZrO₂ is used (Claim 6).

### CITATION LIST

### Patent Literature

[Patent Literature 1] Japanese Unexamined Patent Application Publication No. 2004-087168
[Patent Literature 2] Japanese Unexamined Patent Application Publication No. 2007-012598

### SUMMARY OF INVENTION

### Technical Problem

When the porous heat resistance layer (HRL layer) including an insulating inorganic filler composed of at least one type selected from the group consisting of A;₂O₃, SiO₂, MgO, TiO₂, and ZrO₂ as disclosed in Patent Literature 2 is used for the non-aqueous electrolyte secondary battery in which the overcharge inhibitor is added to the non-aqueous electrolyte and the current interruption mechanism that interrupts charging when the battery internal pressure becomes equal to or more than a predetermined value during charging is mounted, the insulating inorganic filler adsorbs protons generated when the overcharge inhibitor is dissolved during the overcharge state, or adsorbs hydrogen gas generated on the negative electrode. This may make it difficult for the current interruption mechanism to operate satisfactorily.

The above-mentioned insulating inorganic filler has a hydroxyl group on the surface thereof, and thus adsorbs protons. The above-mentioned insulating inorganic filler may adsorb hydrogen due to a catalytic effect.

When the additive amount of the overcharge inhibitor is increased so as to enhance safety by increasing the sensitivity for detecting a rise in internal pressure, the battery capacity tends to decrease. Accordingly, there is a limitation on the additive amount.

The present invention has been made in view of the above-mentioned circumstances, and an object of the present invention is to provide a non-aqueous electrolyte secondary battery excellent in resistance to an external stress and capable of increasing the sensitivity for detecting a rise in internal pressure during an overcharge state, without deteriorating battery performances such as a battery capacity.

### Solution to Problem

A non-aqueous electrolyte secondary battery according to the present invention includes: a positive electrode; a negative electrode; a porous heat resistance layer (HRL (Heat Resistance Layer)) disposed between the positive electrode and the negative electrode and including an insulating inorganic filler and a binder; a non-aqueous electrolyte including an overcharge inhibitor that is dissolved and generates protons during an overcharge state; and a current interruption mechanism that interrupts charging when a battery internal pressure becomes equal to or more than a predetermined value during charging. At least a part of the insulating inorganic filler of the porous heat resistance layer (HRL layer) is formed of proton conductive ceramic.

### Advantageous Effects of Invention

According to the present invention, it is possible to provide a non-aqueous electrolyte secondary battery excellent in resistance to an external stress and capable of increasing the sensitivity for detecting a rise in internal pressure during an overcharge state, without deteriorating battery performances such as a battery capacity.

### BRIEF DESCRIPTION OF DRAWINGS

FIG. 1 is an overall view schematically showing a configuration example of a non-aqueous electrolyte secondary battery according to the present invention; and

FIG. 2 is a partial sectional view of the non-aqueous electrolyte secondary battery shown in FIG. 1.

### DESCRIPTION OF EMBODIMENTS

The present invention will be described in detail below.

A non-aqueous electrolyte secondary battery according to the present invention includes: a positive electrode; a negative electrode; a porous heat resistance layer (HRL layer) disposed between the positive electrode and the negative electrode and including an insulating inorganic filler and a binder; a non-aqueous electrolyte including an overcharge inhibitor that is dissolved and generates protons during an overcharge state; and a current interruption mechanism that interrupts charging when a battery internal pressure becomes equal to or more than a predetermined value during charging. At least a part of the insulating inorganic filler of the porous heat resistance layer (HRL layer) is formed of proton conductive ceramic.

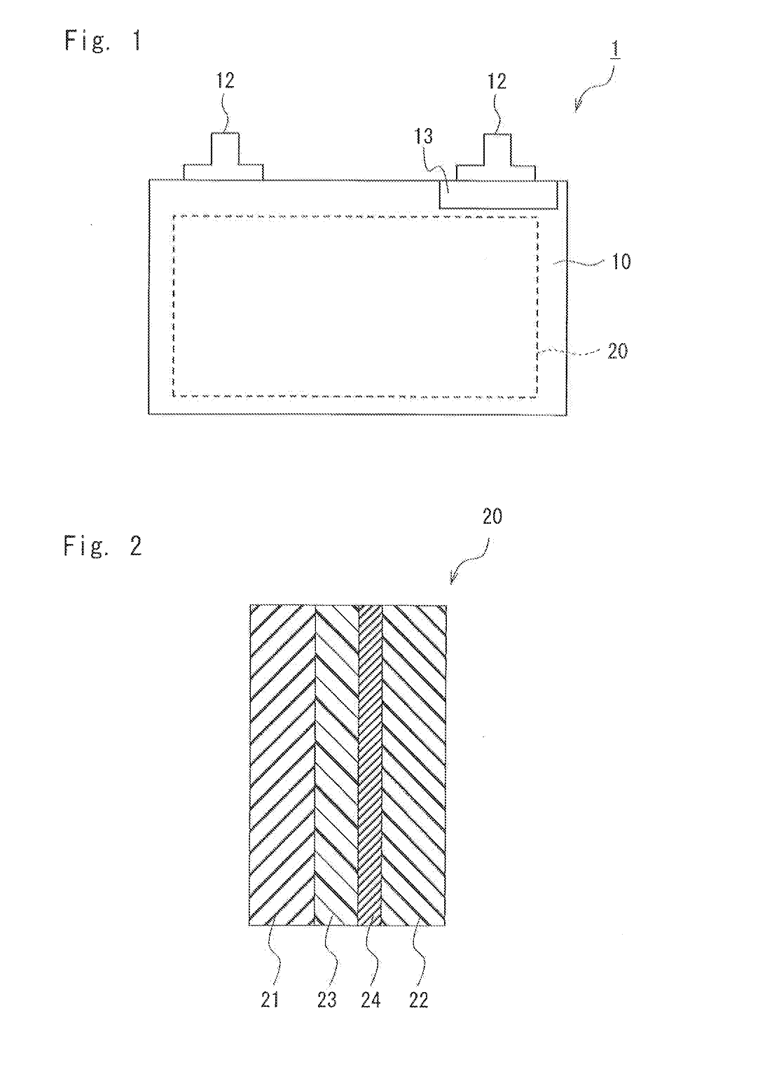

FIGS. 1 and 2 schematically show a configuration example of the non-aqueous electrolyte secondary battery. FIG. 1 is an overall view thereof, and FIG. 2 is a partial sectional view thereof FIGS. 1 and 2 are schematic views.

A non-aqueous electrolyte secondary battery 1 shown in FIG. 1 has a configuration in which a stacked structure 20 shown in FIG. 2 and a non-aqueous electrolyte (a reference numeral of which is omitted) with an overcharge inhibitor are housed in an exterior body 11.

The stacked structure 20 has a structure in which a positive electrode 21 having a particulate positive-electrode active material coated on a collector, a negative electrode 22 having a particulate negative-electrode active material coated on a collector, a resin separator 23, and a porous heat resistance layer (HRL layer) 24 are stacked.

The porous heat resistance layer (HRL layer) is used as a member that isolates the positive electrode and the negative electrode, in place of a resin separator which has been widely used heretofore, or in combination with the resin separator which has been widely used heretofore.

As long as the porous heat resistance layer (HRL layer) 24 is disposed between the positive electrode 21 and the negative electrode 22, the layout position of the porous heat resistance layer 24 is not particularly limited. For example, the porous heat resistance layer 24 can be formed on the surface of the positive electrode 21, the surface of the negative electrode 22, the surface of the resin separator 23, or the surface of an electrode mixture layer (not shown) which is provided, if necessary, so as to integrate the positive electrode 21 and the negative electrode 22.

As shown in FIG. 1 of Patent Literature 2, which is described in the “Background Art” section, a pair of the positive electrode 21 and the negative electrode 22 may be isolated only with the porous heat resistance layer (HRL layer) 24 interposed therebetween, without using the resin separator 23 which has been widely used heretofore.

In the non-aqueous electrolyte secondary battery 1, a current interruption mechanism 13 that interrupts charging when the battery internal pressure becomes equal to or more than a predetermined value during charging is provided in the exterior body 11. The place where the current interruption mechanism 13 is installed is designed depending on the current interruption operation.

In order to increase the sensitivity for detecting a rise in internal pressure, an overcharge inhibitor that is dissolved and generates protons during the overcharge state is added to the non-aqueous electrolyte. In this configuration, the overcharge inhibitor included in the non-aqueous electrolyte is dissolved and generates protons during the overcharge state, and the protons are reduced at the negative electrode, so that hydrogen gas is generated. The generation of gas causes the battery internal pressure to rise, which allows the current interruption mechanism 13 to interrupt a current.

A known mechanism can be employed as the current interruption mechanism 13.

Examples of the current interruption mechanism 13 may include a structure which is deformed due to a rise of the battery internal pressure and disconnects a contact of a charge current; an external circuit which allows a sensor to detect a battery internal pressure and stops charging; an external circuit which allows a sensor to detect a deformation of a battery due to the battery internal pressure and stops charging; and a structure which is deformed due to a rise of the battery internal pressure and causes a short-circuit between the positive electrode and the negative electrode.

For example, the structure which is deformed due to a rise of the battery internal pressure and disconnects a contact of a charge current is preferable, because the structure is simple and has an excellent current interruption effect.

The external surface of the exterior body 11 is provided with two terminals (a plus terminal and a minus terminal) 12 for external connection.

### <Porous Heat Resistance Layer (HRL Layer)>

Since the non-aqueous electrolyte secondary battery according to the present invention includes a porous heat resistance layer (HRL layer), the non-aqueous electrolyte secondary battery is excellent in resistance to an external stress.

As described in the “Solution to Problem” section, when the porous heat resistance layer (HRL layer) including an insulating inorganic filler composed of at least one type selected from the group consisting of Al₂O₃, SiO₂, MgO, TiO₂, and ZrO₂ as disclosed in Patent Literature 2 is used for the non-aqueous electrolyte secondary battery in which the overcharge inhibitor is added to the non-aqueous electrolyte and the current interruption mechanism that interrupts charging when the battery internal pressure becomes equal to or more than a predetermined value during charging is mounted, the insulating inorganic filler adsorbs protons generated when the overcharge inhibitor is dissolved during the overcharge state, or adsorbs hydrogen gas generated on the negative electrode. This may make it difficult for the current interruption mechanism to operate satisfactorily,

The above-mentioned insulating inorganic filler has a hydroxyl group on the surface thereof, and thus adsorbs protons. The above-mentioned insulating inorganic fiber may adsorb hydrogen due to a catalytic effect.

In the non-aqueous electrolyte secondary battery according to the present invention, at least a part of the insulating inorganic filler constituting the porous heat resistance layer (HRL layer) is formed of proton conductive ceramic.

In the configuration described above, even when protons, which are generated when the overcharge inhibitor of the insulating inorganic filler is dissolved during the overcharge state, are adsorbed in the porous heat resistance layer (HRL layer), the protons are released and do not remain on the porous heat resistance layer (HRL layer). The above-mentioned proton conductive ceramic has low hydrogen adsorption properties. Since the adsorption of protons and hydrogen gas in the porous heat resistance layer (HRL layer) is suppressed in the present invention, the current interruption mechanism operates satisfactorily.

According to the present invention, there is no need to increase the additive amount of the overcharge inhibitor, which makes it possible to increase the sensitivity for detecting a rise in internal pressure during the overcharge state, without deteriorating battery performances such as a battery capacity.

The proton conductive ceramic has a higher electrical resistance than that of non-proton conductive ceramic. The use of proton conductive ceramic provides the effect of enhancing the insulating performance of the porous heat resistance layer (HRL layer) and preventing short-circuiting at a higher level.

Examples of the insulating inorganic filler used in the present invention include ceramic particles including at least one type of proton conductive ceramic, and ceramic particles in which at least a part of the surface of at least one type of non-proton conductive ceramic particles is coated with ceramic including at least one type of proton conductive ceramic.

In the porous heat resistance layer (HRL layer), a gap of the particulate insulating inorganic filler forms an ion-conducting pore. In any of the ceramic particles illustrated above, at least a part of the surface of the insulating inorganic filler is formed of proton conductive ceramic. Such a configuration is preferable because proton conductive ceramic present on the wall surface of the ion-conducting pore improves the ion conductivity of the porous heat resistance layer (HRL layer).

The proton conductive ceramic is not particularly limited, as long as the proton conductive ceramic has proton conductivity.

The proton conductive ceramic preferably includes at least one type of metal oxide represented by the following general formula (I):

AB₁₋ₓCₓO₃₋ₐ (I)

(where A represents Ba and/or Sr, B represents Ce and/or Sr, C represents at least one type of additional element, 0≦x<1, and a≧0).

Examples of the metal oxide represented by the above general formula (I) include BaCeO₃, SrZrO₃, SrCeO₃, BaZrO₃, ceramic including optional ingredients with these materials as matrix oxide, and a combination thereof.

It is especially preferable that the proton conductive ceramic include at least one type of metal oxide represented by the following general formula (Ia):

AB₁₋ₓCₓO₃₋ₐ (Ia)

(where A represents Ba and/or Sr, B represents Ce and/or Sr, C represents Y and/or Yb, 0<x<1, and a≧0).

The valence of Ce or Zr varies when Y and/or Yb is added to BaCeO₃, SrZrO₃, SrCeO₃, BaZrO₃, or the like, with the result that the proton conductivity is preferably improved.

In at least one type of metal oxide represented by the above general formula (Ia), the additive amount x of the additional element is especially preferably in the range from 0.01 to 0.5.

If the additive amount x is extremely small, the effect of adding Y and/or Yb may not he filly obtained. If the additive amount x is extremely large, the additional element is not satisfactorily dissolved, which may cause precipitation of different phases.

Examples of the non-proton conductive ceramic include Al₂O₃, SiO₂, MgO, TiO₂, ZrO₂, ceramic including optional ingredients with these materials as matrix oxide, and a combination thereof.

A method for coating at least a part of the surface of the non-proton conductive ceramic particles with ceramic including at least one type of proton conductive ceramic is not particularly limited.

Examples of the method include a method in which a solution or slurry including the precursor of the metal oxide represented by the above general formula (I) is sprayed on the non-proton conductive ceramic particles, and the non-proton conductive ceramic particles are dried and calcined.

The precursor of the metal oxide is not particularly limited. For example, acetate of a metal constituting the metal oxide can be used.

As an example of the coating method, the case in which at least a part of the surface of the non-proton conductive ceramic particles is coated with BaCeO₃ will he described.

Ethylene diamine tetra-acetic acid (EDTA) is dissolved in ammonia water. Cerium acetate is added to the solution, and ethylene glycol is further added to the solution as a stabilizer. The solution thus obtained is heated to dissolve the components. Further, barium acetate is added to the solution, and the solution is heated again to dissolve the components. The precursor solution thus obtained can be directly used, or can be condensed and used as a slurry, if necessary.

The concentration of the precursor in the solution or slurry of the precursor is not particularly limited. For example, 0.3 to 0.6 mol/L is preferable.

The obtained solution or slurry of the precursor is sprayed on the non-proton conductive ceramic particles, and the non-proton conductive ceramic particles are dried preferably at 100 to 150° C. and are calcined preferably at 1000 to 1400° C. In the manner as described above, at least a part of the surface of the non-proton conductive ceramic particles can be coated with BaCeO₃.

The thickness of a coating is not particularly limited. For example, a thickness of 0.5 to 1.0 μm is preferable.

If the thickness of the coating is extremely small, the effect of coating is not sufficiently obtained. If the thickness of the coating is extremely large, it is difficult to perform uniform coating.

A mean particle diameter of ceramic particles forming the porous heat resistance layer (HRL layer) is not particularly limited. For example, a mean particle diameter of 0.3 to 4 μm is preferable. Within such a range, a satisfactory porosity and a satisfactory strength for ion conduction can be preferably obtained (see paragraph 0034 of Patent Literature 2).

As the hinder that constitutes the porous heat resistance layer (HRL layer), a known binder can be used. Examples of the binder include polyvinylidene fluoride (PVDF), modified acrylic rubber, and a combination thereof.

In general, a binder absorbs a non-aqueous electrolyte and swells after the formation of the battery. Accordingly, it is preferable that the additive amount of the binder be small. Since the binding effect can be obtained by only a small amount of polyvinylidene fluoride and acrylic rubber described above, the additive amount can be preferably reduced. The amount of the binder is not particularly limited. An amount of 0.3 to 8.5 mass % is preferably used, for example, with respect to insulating filler, so as to obtain a satisfactory binding effect of the insulating filler and suppress swelling of the binder due to the absorption of a non-aqueous electrolyte (see paragraph 0036 of Patent Literature 2).

A method for manufacturing the porous heat resistance layer (HRL layer) is not particularly limited. The porous heat resistance layer (HRL layer) can be manufactured by, for example, coating the surface of the positive electrode, the negative electrode, the separator, or the like with a mixture obtained by mixing an insulating filler, a binder, and a dispersion medium, and drying the mixture with far-infrared rays, hot air, or the like.

The non-aqueous electrolyte secondary battery according to the present invention incorporates the porous heat resistance layer (HRL layer), which includes an insulating inorganic filler and a binder and has high rigidity, and thus is excellent in resistance to an external stress.

As described in the “Solution to Problem” section, when the porous heat resistance layer (HRL layer) including an insulating inorganic filler composed of at least one type selected from the group consisting of Al₂O₃, SiO₂, MgO, TiO₂, and ZrO₂ as disclosed in Patent Literature 2 is used for the non-aqueous electrolyte secondary battery in which the overcharge inhibitor is added to the non-aqueous electrolyte and the current interruption mechanism that interrupts charging when the battery internal pressure becomes equal to or more than a predetermined value during charging is mounted, the insulating inorganic filler adsorbs protons generated when the overcharge inhibitor is dissolved during the overcharge state, or adsorbs hydrogen gas generated on the negative electrode. This may make it difficult for the current interruption mechanism to operate satisfactorily.

Further, when the additive amount of the overcharge inhibitor is increased so as to enhance the safety by increasing the sensitivity for detecting a rise in internal pressure, the battery capacity tends to decrease. Accordingly, there is a limitation on the additive amount.

In the present invention, at least a part of the insulating filler that constitutes the porous heat resistance layer (HRL layer) is formed of proton conductive ceramic.

According to the present invention having such a configuration, it is possible to provide a non-aqueous electrolyte secondary battery excellent in resistance to an external stress and capable of increasing the sensitivity for detecting a rise in internal pressure during the overcharge state, without deteriorating battery performances such as a battery capacity.

Examples of the non-aqueous electrolyte secondary battery include a lithium ion secondary battery. The main constituent elements of the non-aqueous electrolyte secondary battery will he described below h taking a lithium ion secondary battery as an example.

### <Positive Electrode>

The positive electrode can be manufactured by a known method in which a positive-electrode active material is coated on a positive electrode collector such as aluminum foil.

A known positive-electrode active material is not particularly limited. For example, a lithium-containing composite oxide such as LiCoO₂, LiMnO₂, LiMn₂O₄, LiNiO₂, LiNiCoₓCo₍₁₋ₓ₎O₂, and LiNiₓCo_{y}Mn_{(1-x-y)}O₂ can be used.

For example, a dispersant such as N-methyl-2-pyrrolidone is used, and the above-mentioned positive-electrode active material, a conducting agent, such as carbon powder, and a binder, such as polyvinylidene fluoride (PVDF), are mixed together to thereby obtain a slurry. This slurry is coated on a positive electrode collector, such as aluminum foil, and is dried and pressed to thereby obtain the positive electrode. The mass per unit area of the positive electrode is not particularly limited. A mass per unit area of 1.5 to 15 mg/cm² is preferable. If the mass per unit area of the positive electrode is extremely small, it is difficult to perform uniform coating. If the mass per unit area of the positive electrode is extremely large, the coating may be removed from the collector.

### <Negative Electrode>

The negative electrode can be manufactured by a known method in which a negative-electrode active material is coated on a negative electrode collector such as copper foil.

The negative-electrode active material is not particularly limited. A negative-electrode active material having a lithium storage capacity at 2.0 V or lower on the basis of Li/Li+ is preferably used. Examples of the negative-electrode active material include carbon such as graphite, metallic lithium, a lithium alloy, transition metal oxide/transition metal nitride/transition metal sulfide capable of doping/undoping of lithium ions, and a combination thereof.

For example, a dispersant such as water is used, and the above-mentioned negative-electrode active material, a binder, such as a modified styrene-butadiene copolymer latex, and, if necessary, a thickener, such as carboxymethyl cellulose-Na salt (CMC), are mixed together to thereby obtain a slurry. This slurry is coated on a negative electrode collector, such as copper foil, and is dried and pressed to thereby obtain the negative electrode.

The mass per unit area of the negative electrode is not particularly limited. A mass per unit area of 1.5 to 15 mg/cm² is preferable. If the mass per unit area of the negative electrode is extremely small, it is difficult to perform uniform coating. If the mass per unit area of the negative electrode is extremely large, the coating may be removed from the collector.

In lithium ion secondary batteries, a carbon material capable of absorbing and emitting lithium is widely used as the negative-electrode active material. In particular, highly crystalline carbon such as graphite has such properties as a flat discharge potential, a high true density, and an excellent tilling property. For this reason, highly crystalline carbon is used for many negative-electrode active materials of commercially-available lithium ion secondary batteries. Accordingly, graphite or the like is especially preferably used as the negative-electrode active material.

### <Non-Aqueous Electrolyte>

A known non-aqueous electrolyte can be used as the non-aqueous electrolyte. A liquid, gel, or solid non-aqueous electrolyte can be used.

For example, a non-aqueous electrolyte solution obtained by dissolving a lithium-containing electrolyte in a mixed solution of a high-dielectric carbonate solvent, such as propylene carbonate or ethylene carbonate, and a low-viscosity carbonate solvent such as diethyl carbonate, methyl ethyl carbonate, or dimethyl carbonate can be used.

As the mixed solvent, for example, a mixed solvent of ethylene carbonate (EC)/dimethyl carbonate (DMC)/ethyl methyl carbonate (EMC) is preferably used.

Examples of the lithium-containing electrolyte include lithium salt such as LiPF₆, LiBF₄, LiClO₄, LiAsF₆, Li₂SiF₆, LiOSO2CₖF₍₂ₖ₊₁₎ (k is an integer ranging from 1 to 8), and LiPFₙ{CₖF₍₂ₖ₊₁₎}₍₆₋ₙ₎ (n is an integer ranging from 1 to 5, and k is an integer ranging from 1 to 8), and a combination thereof.

A known overcharge inhibitor that is dissolved and generates protons during the overcharge state can be used as the overcharge inhibitor. For example, one or more types of overcharge inhibitors disclosed in Patent Literature 1 which is cited in the “Background Art” section can be used.

The “Description of the Prior Art” section of Patent Literature 1 discloses, as examples of the overcharge inhibitor, biphenyls, alkylbenzenes, an alkyl compound substituted with two aromatic groups, fluorine atom substituted aromatic compounds, and chlorine atom substituted biphenyl (paragraphs 0009, 0011, and 0014),

Claim 1 of Patent Literature 1 discloses, as the overcharge inhibitor, at least one type of chlorine atom substituted aromatic compound selected from the group consisting of chlorine atom substituted biphenyl, chlorine atom substituted naphthalene, chlorine atom substituted fluorene, and chlorine atom substituted diphenylmethane.

### <Resin Separator>

Any film may be used as the resin separator, as long as the film electrically isolates the positive electrode and the negative electrode and allows lithium ions to pass therethrough. A porous polymeric film is preferably used.

As the separator, for example, a porous film made of polyolefin, such as a porous film made of PP (polypropylene), a porous film made of PE (polyethylene), or a PP (polypropylene)-PE (polyethylene) stacked porous film is preferably used.

### <Exterior Body>

A known exterior body can be used as the exterior body.

Examples of the type of secondary batteries include a cylindrical type, a coin type, a square type, and a film type. The exterior body can be selected according to a desired type.

### EXAMPLES

Examples and Comparative Examples according to the present invention will be described.

### Examples 1 to 9, Comparative Examples 1 to 5

### <Positive-Electrode Active Material>

As the positive-electrode active material, a lithium composite oxide of a three-dimensional system represented by the following formula was used.

LiMn_{1/3}Co_{1/3}Ni_{1/3}O₂

### <Manufacture of Positive Electrode>

N-methyl-2-pyrrolidone (manufactured by Wako Pure Chemical Industries, Ltd.) was used as a dispersant, and the above-mentioned positive-electrode active material, acetylene black (HS-100 manufactured by Denki Kagaku Kogyo Kabushiki Kaisha) as a conducting agent, and PVDF (KF Polymer #1120 manufactured by Kureha Corporation) as a binder were mixed together at 90/6/4 (mass ratio) to thereby obtain a slurry.

The above-mentioned slurry was coated by a doctor blade method on aluminum foil serving as a collector, and was dried for 30 minutes at 150° C. and pressed by a press machine to thereby obtain the positive electrode. The mass per unit area of the positive electrode was 10 mg/cm² and the thickness thereof was 50 μm.

### <Negative Electrode>

Graphite was used as the negative-electrode active material.

Water was used as a dispersant, and the above-mentioned negative-electrode active material, a modified styrene-butadiene copolymer latex (SBR) as a hinder, and carboxymethyl cellulose-Na salt (CMC) as a thickener were mixed together at 98/1/1 (mass ratio) to thereby obtain a slurry.

The above-mentioned slurry was coated by the doctor blade method on copper foil serving as a collector, and was dried for 30 minutes at 150° C. and pressed by the press machine to thereby obtain the negative electrode. The mass per unit area of the negative electrode was 5 nr cm² and the thickness thereof was 70 μm.

### <Resin Separator>

A commercially-available separator formed of a PE (polyethylene) porous film and having a thickness of 20 μm was prepared.

### <Porous Heat Resistance Layer (HRL Layer)>

In Comparative Example 1, the porous heat resistance layer (HRL layer) was not used.

In Examples 1 to 9 and Comparative Examples 2 to 4, the porous heat resistance layer (HRL layer) was used, and the insulating inorganic fillers shown in Table 1 were used. The average particle diameter of the insulating inorganic fillers used was in the range from 8 to 10 μm.

In Examples 6 to 9, insulating inorganic fillers obtained by coating the surface of non-proton conductive ceramic, which was used in Comparative Examples 1 to 3, with proton conductive ceramic were used.

In Example 6, at least a part of the surface of non-proton conductive ceramic was coated with proton conductive ceramic in the following manner.

First, EDTA was dissolved in ammonia water. Cerium acetate and ethylene glycol as a stabilizer were added to this solution, and the solution was heated to dissolve the components.

Next, barium acetate was added to the solution, and was heated again to dissolve the components.

The obtained precursor solution was condensed to obtain 0.45 mol/L of BaCeO₃ precursor slurry. This precursor slurry was sprayed on Al₂O₃ particles, and the particles were dried for five minutes at 100° C., After that, the particles were calcined for two hours at 1200° C., and the surface of the Al₂O₃ particles was coated with a BaCeO₃ film.

When the particles were observed by a scanning electron microscope (SEM), it was observed that the thickness of the BaCeO₃ film was 0.75 μm and the entire surface of the Al₂O₃ particles was satisfactorily coated with the BaCeO₃ film.

Also in Examples 7 to 9, as in Example 6, acetate was used as a precursor, and the surface of non-proton conductive ceramic was coated with proton conductive ceramic.

In all of the examples, acrylic rubber was used as a hinder. The mass ratio between the insulating inorganic filler and the acrylic rubber was 90:10 (mass ratio). The thickness of the porous heat resistance layer (HRL layer) was 5 μm.

### <Non-Aqueous Electrolyte>

A mixed solution of ethylene carbonate (EC)/dimethyl carbonate (DMC)/ethyl methyl carbonate at 3/3/4 (volume ratio) was used as a solvent, and lithium salt of LiPF₆ was dissolved as an electrolyte at a concentration of 1 mol/L and cyclohexylbenzene (CHB) was dissolved as an overcharge inhibitor at 2 mass %, thereby preparing a non-aqueous electrolyte solution.

### <Manufacture of Lithium Ion Secondary Battery>

In Comparative Example 1, the positive electrode, the negative electrode, and the resin separator as described above were stacked. The stacked structure, a non-aqueous electrolyte, and a film exterior body were used, and a film-type (laminate-type) lithium ion secondary battery was manufactured by a known method.

In Examples 1 to 9 and Comparative Examples 2 to 4, the positive electrode, the negative electrode, the resin separator, and the porous heat resistance layer (HRL layer) as described above were stacked as shown in FIG. 2. The stacked structure, a non-aqueous electrolyte, and a film exterior body were used, and a film-type (laminate-type) lithium ion secondary battery was manufactured by a known method.

### <Overcharge Test>

An overcharge test was conducted on each lithium ion secondary battery obtained in a pretest and Example 1.

The amount of gas generated upon occurrence of an overcharge was obtained by a buoyancy method (Archimedian method) under the conditions of 25° C., 1 C, and a charge voltage of 4.6 V. Before and after the overcharge, the film-type (laminate-type) lithium ion secondary battery was dipped in water, and the volume thereof was obtained from the buoyancy. A change in the volume before and after the overcharge was obtained as the amount of generated gas. The amount of generated gas can be considered as the amount of generated hydrogen gas.

The results are shown in Table 1.

From the comparison between Comparative Example 1 and Comparative Examples 2 to 4, it turned out that the use of the porous heat resistance layer (HRL layer) incorporating an insulating inorganic filler formed of non-proton conductive ceramic considerably reduces the amount of generated hydrogen gas.

From the comparison between Comparative Examples 2 to 4 and Examples 1 to 9, it turned out that the use of the insulating inorganic filler of the porous heat resistance layer (HRL layer), in which the surface of proton conductive ceramic or non-proton conductive ceramic is coated with proton conductive ceramic, increases the amount of generated hydrogen gas to a level approximate to that of Comparative Example 1 in which the porous heat resistance layer (HRL layer) was not used. In particular, in Example 5 in which ceramic obtained by adding Y to BaCeO₃ was used, the amount of generated hydrogen gas was increased as compared with Example 1 in which BaCeO₃ was used.

TABLE 1

| | | | the amount of |
|---|---|---|---|
| | porous heat | | hydrogen gas during |
| | resistance layer | insulating filler | overcharge [cc] |
| Comparative | None | — | 90 |
| Example 1 | | | |
| Comparative | Present | Al₂O₃ | 55 |
| Example 2 | | | |
| Comparative | Present | MgO | 60 |
| Example 3 | | | |
| Comparative | Present | TiO₂ | 57 |
| Example 4 | | | |
| Example 1 | Present | BaCeO₃ | 88 |
| Example 2 | Present | SrZrO₃ | 87 |
| Example 3 | Present | SrCeO₃ | 88 |
| Example 4 | Present | BaZrO₃ | 87 |
| Example 5 | Present | Ba(Ce_{0.9}Y_{0.1})O₃ | 90 |
| Example 6 | Present | Al₂O₃/BaCeO₃ | 86 |
| | | coating | |
| Example 7 | Present | Al₂O₃/SrZrO₃ | 85 |
| | | coating | |
| Example 8 | Present | MgO/BaCeO₃ | 86 |
| | | coating | |
| Example 9 | Present | TiO₂/SrZrO₃ | 85 |
| | | coating | |

### INDUSTRIAL APPLICABILITY

A non-aqueous electrolyte secondary battery according to the present invention is preferably applied to lithium secondary batteries and the like which are mounted in a plug-in hybrid vehicle (PHV) or an electric vehicle (EV).

### REFERENCE SIGNS LIST

1 NON-AQUEOUS ELECTROLYTE SECONDARY BATTERY
11 EXTERIOR BODY
12 TERMINAL
13 CURRENT INTERRUPTION MECHANISM
20 STACKED STRUCTURE
21 POSITIVE ELECTRODE
22 NEGATIVE ELECTRODE
23 RESIN SEPARATOR
24 POROUS HEAT RESISTANCE LAYER (HRL LAYER)

1. A non-aqueous electrolyte secondary battery comprising:
a positive electrode;
a negative electrode;
a porous heat resistance layer disposed between the positive electrode and the negative electrode and including an insulating inorganic filler and a binder;
a non-aqueous electrolyte including an overcharge inhibitor that is dissolved and generates protons during an overcharge state; and
a current interruption mechanism that interrupts charging when a battery internal pressure becomes equal to or more than a predetermined value during charging,
wherein at least a part of the insulating inorganic filler of the porous heat resistance layer is formed of proton conductive ceramic.

2. The non-aqueous electrolyte secondary battery according to claim 1, wherein at least a part of a surface of the insulating inorganic filler is formed of the proton conductive ceramic.

3. The non-aqueous electrolyte secondary battery according to claim 1 or 2, wherein the proton conductive ceramic includes at least one type of metal oxide represented by the following general formula (I):
AB₁₋ₓCₓO₃₋ₐ (I)
(where A represents Ba and/or Sr, B represents Ce and/or Sr, C represents at least one type of any additional element, 0≦x<1, and a≧0)

4. The non-aqueous electrolyte secondary battery according to claim 3, wherein the proton conductive ceramic includes at least one type of metal oxide represented by the following general formula (Ia):
AB₁₋ₓCₓO₃₋ₐ (Ia)
(where A represents Ba and/or Sr, B represents Ce and/or Sr, C represents Y and/or Yb, 0≦x<1, and a≧0)

5. The non-aqueous electrolyte secondary battery according to claim 4, wherein x ranges from 0.01 to 0.5.

6. The non-aqueous electrolyte secondary battery according to claim 1, wherein the non-aqueous electrolyte secondary battery is a lithium ion secondary battery.
